(19) United States
(12) Patent Application Publication
(10) Pub. No.: US 2026/0003641 A1
(43) Pub. Date: Jan. 1, 2026

(54) SLEEP MANAGEMENT FOR RTOS ENVIRONMENT

(71) Applicant: Silicon Laboratories Inc., Austin, TX (US)

(72) Inventors: Jean Francois Deschenes, Ste-Marthe-sur-le-lac (CA); Marylise Monchalin, Montreal (CA)

(21) Appl. No.: 18/760,801

(22) Filed: Jul. 1, 2024

(51) Int. Cl. G06F 9/4401

(52) U.S. Cl. CPC G06F 9/4418

(57) ABSTRACT

A system and method for managing sleep mode in a real time operating system is disclosed. The system utilizes certain ARM processors which incorporate a SLEEP ON EXIT feature. This feature allows the processing unit to enter sleep mode once the lowest priority exception handler has terminated operation. Additionally, the system utilizes thread mode, or user mode, without the use of an idle task. The functions typically performed by the idle task are now incorporated into various interrupt service routines and the PendSV exception handler. Further, the system supports two or more different sleep modes.

### FIELD

This disclosure describes a system and method to reduce the power consumption of a device using a real time operating system that employs a processing unit that supports a “Sleep on Exit” feature.

### BACKGROUND

Real time operating systems (RTOS) typically rely on an idle task or an idle context that operates in user mode to determine when a sleep mode may be entered.

FIG. 1 shows a timing diagram of a system that is utilizing an RTOS. In a real time operating system, there are exception handlers and interrupts that are executed in handler mode, as well as tasks which are executed in thread or user mode. All of these entities are software programs, which are implemented as instructions disposed on a non-transitory computer readable medium. Further, FIG. 1 is specific to ARM processors, which implement a PendSV exception handler, which typically operates at the lowest exception priority.

In this figure, the system begins by executing Task A. When Task A completes, or is stalled waiting for some external event, the operating system scheduler is invoked, which calls the PendSV exception handler. The PendSV exception handler is used by ARM processors to facilitate the context switch between tasks.

At this time, the PendSV exception handler determines that there are no ready tasks to execute. Consequently, it calls the idle task, which executes a WFI (Wait for interrupt) instruction, which puts the processing unit into a sleep mode. Further, the processing unit may support different sleep modes, where each represents a tradeoff between power consumption and wakeup time. The decision of which sleep mode to enter is typically applied by the idle task prior to execution of the WFI instruction.

At a later time, the processing unit awakens due to an interrupt, and the processing unit resumes executing the idle task. The processing unit must preserve the context of the idle task, such as by storing it in memory, before the processing unit may begin executing interrupt service routine (ISR) 1.

After the ISR1 has completed, the processing unit returns to the thread or user mode, and again executes the idle task. At a later time, a second interrupt occurs, which wakes the processing unit. Again, the processing unit resumes executing the idle task. The processing unit must preserve the context of the idle task, such as by storing it in memory, before the processing unit may begin executing interrupt service routine (ISR) 2.

After the ISR2 has completed, the processing unit returns to the thread or user mode, and again executes the idle task. However, this time, an external event has occurred that allows Task A to resume execution. Thus, the OS scheduler invokes the PendSV exception handler, which facilitates the context switch to Task A.

Note that in this simple example, the idle task was executed five times, which required its context to be saved and restored as well. This is wasted time, as no useful work is performed at these times.

Therefore, it would be beneficial if there was a system and method that allows a processing unit to operate in both handler mode and thread or user mode, but did not require the inclusion of an idle task.

### SUMMARY

A system and method for managing sleep mode in a real time operating system is disclosed. The system utilizes certain ARM processors which incorporate a SLEEP ON EXIT feature. This feature allows the processing unit to enter sleep mode once the lowest priority exception handler has terminated operation. Additionally, the system utilizes thread mode, or user mode, without the use of an idle task. The functions typically performed by the idle task are now incorporated into various interrupt service routines and the PendSV exception handler. Further, the system supports two or more different sleep modes.

According to one embodiment, a method of managing sleep mode in a real time operating system (RTOS) environment is disclosed. The method comprises operating an ARM processor in both handler mode and thread mode; implementing a SLEEP ON EXIT feature of an ARM processor to enter sleep mode after all interrupts are serviced and no tasks are ready to execute; and disabling the SLEEP ON EXIT feature when a task is determined to be ready to execute. In some embodiments, a PendSV exception handler is a lowest priority exception and is used to enable the SLEEP ON EXIT feature when no tasks are ready to execute. In certain embodiments, the PendSV exception handler determines which one of two or more sleep modes to enter if the SLEEP ON EXIT feature is enabled. In certain embodiments, the PendSV exception handler restores context of a task if the task is ready to execute. In some embodiments, each interrupt service routine includes an ISR epilogue to execute post-sleep instructions. In certain embodiments, the ISR epilogue checks if the SLEEP ON EXIT feature has been disabled. In some embodiments, the thread mode does not include an idle task. In some embodiments, sleep mode is always entered from handler mode. In certain embodiments, sleep mode is entered from an interrupt service routine.

According to another embodiment, a device is disclosed. The device comprises an ARM processor; a memory device in communication with the ARM processor, containing instructions, which when executed by the ARM processor, allow the ARM processor to: operate in both handler mode and thread mode; implement a SLEEP ON EXIT feature to enter sleep mode after all interrupts are serviced and no tasks are ready to execute; and disable the SLEEP ON EXIT feature when a task is determined to be ready to execute. In some embodiments, the instructions include a PendSV exception handler, which is a lowest priority exception and is used to enable the SLEEP ON EXIT feature when no tasks are ready to execute. In certain embodiments, the PendSV exception handler determines which one of two or more sleep modes to enter if the SLEEP ON EXIT feature is enabled. In certain embodiments, the PendSV exception handler restores context of a task if the task is ready to execute. In some embodiments, the instructions include one or more interrupt service routines, and each interrupt service routine includes an ISR epilogue to execute post-sleep instructions. In certain embodiments, the ISR epilogue checks if the SLEEP ON EXIT feature has been disabled. In some embodiments, the instructions do not include an idle task that executes in thread mode. In some embodiments, sleep mode is always entered from handler mode. In certain embodiments, sleep mode is entered from an interrupt service routine.

### BRIEF DESCRIPTION OF THE DRAWINGS

For a better understanding of the present disclosure, reference is made to the accompanying drawings, in which like elements are referenced with like numerals, and in which:

FIG. 1 shows a timing diagram illustrating conventional operation of a Real Time Operating System;

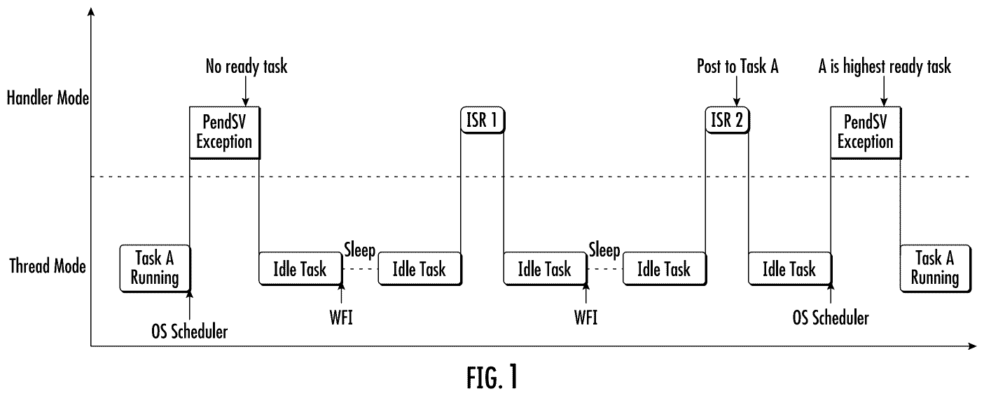

FIG. 2 shows a block diagram of a representative device that may be used to implement the disclosed methods;

FIG. 3 shows a timing diagram illustrating the operation of the Real Time Operating System according to one embodiment;

FIG. 4 shows the operation of the PendSV exception handler; and

FIG. 5 shows the operation of the interrupt service routine epilogue, which replaces part of the functionality of an idle task.

### DETAILED DESCRIPTION

This disclosure describes a system and method by which a real time operating system may control power management of the device and processing unit. Much of this disclosure is specific to processing units that support a “sleep on exit” instruction.

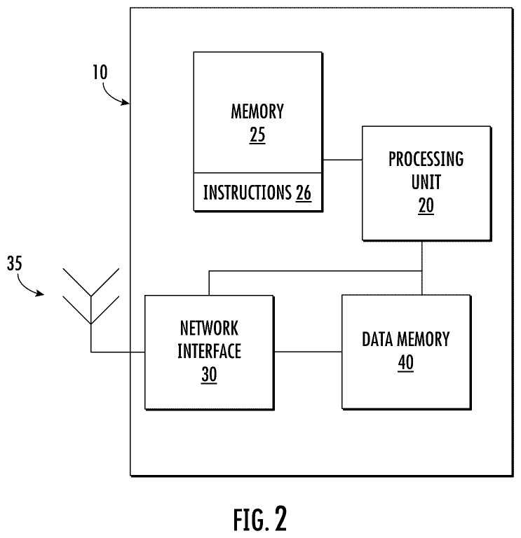

FIG. 2 shows a block diagram of a representative device 10 that may be used to implement the disclosed methods. This device may be configured to be a low power device that reduces power consumption by using one or more sleep modes.

The device 10 has a processing unit 20 and an associated memory device 25. The processing unit 20 may be any suitable component, such as a microprocessor, embedded processor, an application specific circuit, a programmable circuit, a microcontroller, or another similar device. In certain embodiments, the processing unit 20 is an ARM CORTEX-M processor.

The processing unit 20 may be configured to operate in two different modes; a handler mode, and a thread, or user, mode. The handler mode is used to service interrupts and other exceptions. The thread or user mode is a lower priority mode, which may be paused when a higher priority event requires processing.

The processing unit 20 may support various power management features. These include special instructions, such as “wait for Interrupt” (WFI), which places the processing unit in a sleep mode until an interrupt is received. Other special instructions may include “Sleep on Exit”, which causes the processing unit 20 to enter sleep mode when all handlers and interrupt service routines operating in handler mode have completed.

The device 10 may also include different power modes, which include an active mode, and at least two sleep modes, including a sleep mode and a deep sleep mode, which is the lowest power state. Note that there may be additional sleep modes. There is a set of peripherals within the device 10 that perform various functions, such as the processing unit 20, the network interface 30, the serial interfaces, the I/O ports, the clock management block, the onboard memory, and others. For each power mode, some set of these peripherals is active while others may be powered off. Further, at the lowest power mode, referred to as deep sleep, the clock that is provided to the processing unit 20 may be reduced in frequency or disabled. Note that while the lower power modes (sleep and deep sleep) consume less power, there is a drawback, which is that the time to return to fully active mode is increased, as the clock frequency needs to be increased and stabilized before the processing unit 20 may begin operating.

The memory device 25, which may be internal to the processing unit 20, external, or a combination thereof, contains the instructions 26, which, when executed by the processing unit 20, enable the device 10 to perform the functions described herein. This memory device 25 may be a non-volatile memory, such as a FLASH ROM, an electrically erasable ROM or other suitable device. In other embodiments, the memory device 25 may be a volatile memory, such as a RAM or DRAM.

The device 10 may also include a network interface 30 that connects with a wireless network using an antenna 35. Alternatively, a wired network may be used.

The device 10 may include a data memory device 40 in which data that is received and transmitted by the network interface 30 is stored. This data memory device 40 is traditionally a volatile memory. The processing unit 20 has the ability to read and write the data memory device 40 so as to communicate with the other devices in the network. In some embodiments, the data memory device 40 contains a receive queue for packets that are received by the network interface 30 and a transmission queue for packets that are to be transmitted by the network interface 30.

Although not shown, the device 10 also has a power supply, which may be a battery.

While the processing unit 20, the memory device 25, the network interface 30 and the data memory device 40 are shown in FIG. 2 as separate components, it is understood that some or all of these components may be integrated into a single electronic component. Rather, FIG. 2 is used to illustrate the functionality of the device 10, not its physical configuration.

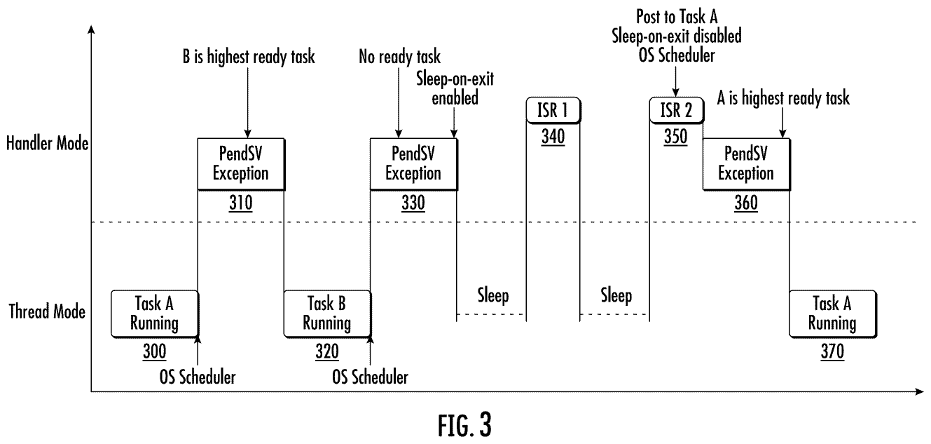

FIG. 3 shows a timing diagram showing the operation of the RTOS according to one embodiment. Note that the idle task is no longer used.

As noted above, in a real time operating system, there are exception handlers and interrupt service routines that are executed in handler mode, as well as tasks which are executed in thread or user mode. All of these entities are software programs, which are implemented as instructions disposed on a non-transitory computer readable medium. Further, FIG. 3 is specific to ARM processors, which implement a PendSV exception handler, which typically operates at the lowest exception priority.

In FIG. 3, the processing unit 20 begins by executing Task A (see Box 300) in thread mode. When Task A completes, or is stalled waiting for some external event, the operating system scheduler is invoked, which raises the PendSV exception handler (Box 310). The PendSV exception handler is used by ARM processors to facilitate the context switch between tasks. The PendSV exception handler is aware that Task B is the highest priority task that is ready to execute. It then executes a context switch to allow Task B to begin execution in thread or user mode (see Box 320). At a later time, Task B may complete or be stalled waiting for an external event. The operating system scheduler (OS Scheduler) is then invoked, which calls the PendSV exception handler again (see Box 330). At this time, it is determined that there are no tasks that are ready to execute. Because of this, the PendSv exception handler sets the SLEEPONEXIT bit in the system control register (SCR) of the processing unit 20. When set, the SLEEPONEXIT bit informs the processing unit 20 to enter sleep mode upon completion of all exception handlers and interrupt service routines executing in handler mode. This bit is intended to be used only with systems that operate only in handler mode. Because the PendSV exception handler is executed at the lowest priority of all exceptions, completion of the PendSV exception handler means that all exceptions must be complete.

The processing unit 20 then enters sleep mode. Later, an interrupt is received, which is serviced by a first interrupt service routine, named ISR1 (see Box 340). When this ISR1 completes, since there are no other exception handlers to execute, the processing unit 20 returns to sleep mode. At a later time, another interrupt is received, which is serviced by a second interrupt service routine, named ISR2 (see Box 350). This interrupt may be the event that Task A has been waiting on. Thus, the ISR2 may call an RTOS function that is associated with this Task A, which then clears the SLEEPONEXIT bit, since it is aware that there are tasks that are now ready to execute. Further, that RTOS function realizes that a context switch is necessary so that Task A may execute and thus calls the OS scheduler. The OS scheduler is a special operating system function that may execute in either thread or handler mode and serves to determine the next ready task to execute based on certain parameters. In this scenario, the OS scheduler will raise the PendSV exception handler to execute (see Box 360). Following execution of the PendSV exception handler, Task A begins executing (see Box 370).

As noted above, there is no idle task. Consequently, the functions previously performed by the idle task must now be performed elsewhere in the software. Specifically, the idle task was responsible for determining which energy mode to use when entering sleep. It was also responsible for certain pre-sleep and post-sleep operations, such as changing the frequency of the incoming clock for certain energy modes. The PendSV exception handler is now responsible for the pre-sleep operations, while each ISR is now responsible for the post-sleep operations. These software programs are described in more detail below.

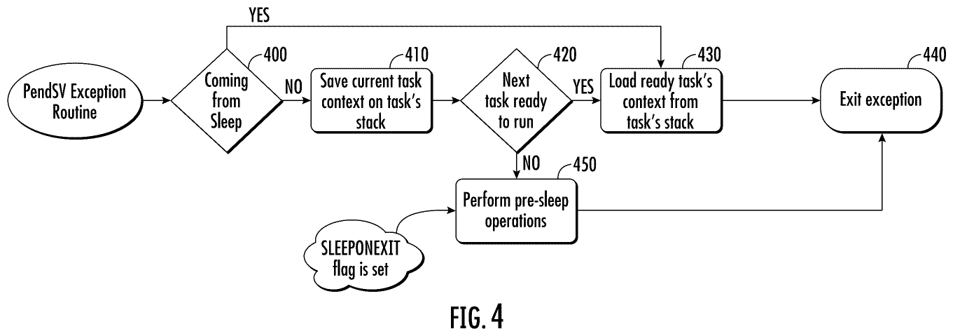

FIG. 4 shows the operation of the PendSV exception handler in more detail.

First, as shown in Box 400, the PendSV exception handler detects whether it was entered from sleep mode, or was invoked by the OS scheduler from a previously executed task. Referring back to FIG. 3, it can be seen that Boxes 310 and 330 were not entered from sleep mode, while Box 360 was entered from sleep mode (after ISR2 was executed).

If the PendSV exception handler was invoked after sleep mode, this implies that an interrupt service routine enabled a task to be ready to execute (as shown in Box 350). In this case, the PendSV exception handler loads the context of that ready task from the task's stack, as shown in Box 430. The operation of the PendSV exception handler is then complete, as shown in Box 440.

However, if the PendSV exception handler was not entered from sleep mode, that implies that there is a task whose context must be saved. Therefore, the PendSV exception handler saves the current task's context in the task's stack, as shown in Box 410. The PendSV exception handler then checks if there is another task that is ready to execute, as shown in Box 420. If there is another ready task, the PendSV exception handler loads the context of that ready task from the task's stack, as shown in Box 430. The operation of the PendSV exception handler is then complete, as shown in Box 440.

If there is not another ready task, the PendSV exception handler performs pre-sleep operations, as shown in Box 450. One of the actions taken during the pre-sleep operations is to set the SLEEPONEXIT bit.

Pre-sleep operations also include determining which power mode to enter (sleep mode or deep sleep mode). This may be determined based on various factors, such as whether another hardware function (such as the DMA machine) is active or how quickly it is expected that the processing unit 20 must wake again. As noted above, in deep sleep mode, the high frequency clock is disabled, so additional time is required to exit deep sleep mode. Further, if it is determined that deep sleep mode will be entered, the pre-sleep operations may include changing the clock frequency. Finally, the PendSV exception handler sets the SLEEPONEXIT flag is there are no tasks ready to execute.

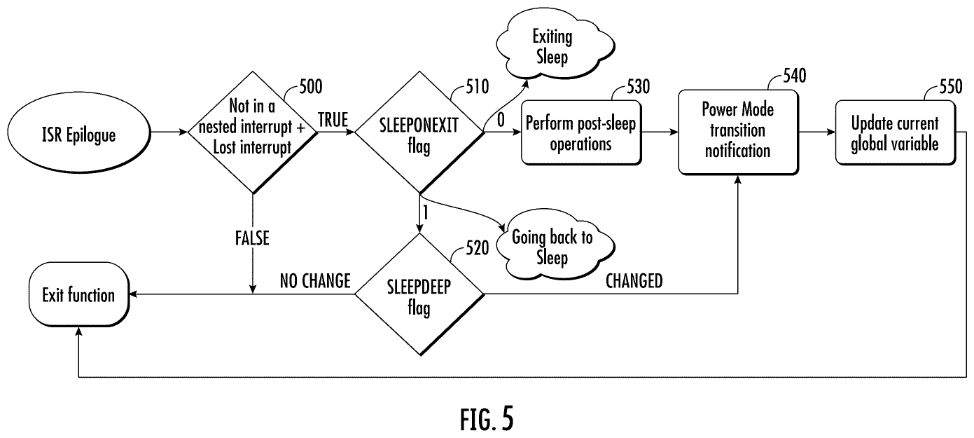

As noted above, because there is no idle task, the functions that are typically performed after waking from sleep must be performed elsewhere, such as within each interrupt service routine. FIG. 5 shows the operation of each ISR with respect to post-sleep functions. Note that this set of operations may be called via a ISR epilogue. This ISR epilogue may be executed at the end of each ISR, after all other instructions have been executed. First, as shown in Box 500, the ISR epilogue checks whether this is the last interrupt to be executed. If not, no action is taken, and the ISR epilogue terminates. If, however, this is the last interrupt to be serviced, the ISR epilogue then checks the SLEEPONEXIT flag, as shown in Box 510. If the SLEEPONEXIT flag is set, this means that the processing unit 20 will enter one of the sleep modes once this ISR completes execution. In this case, the ISR epilogue checks the state of the SLEEPDEEP flag, as shown in Box 520. If this flag is unchanged, then the ISR epilogue simply exits. However, if the SLEEPDEEP flag has been changed, the ISR epilogue may generate a power mode transition notification, as shown in Box 540. It may then update the global variable that represents the current power mode, as shown in Box 550. This allows other tasks and exception handlers to be aware of the sleep mode currently being used. The ISR epilogue then exits. If, however, the SLEEPONEXIT flag is no longer set (see Box 510), this means that there is a task that is ready to execute. Consequently, the ISR epilogue may perform post sleep operations, as shown in Box 530. One such operation may be to change the frequency of the clock. Specifically, as described above, the frequency of the clock may be lowered when entering deep sleep mode to save power. Thus, if the processing unit 20 will be executing in thread mode, the ISR epilogue may increase the frequency of the clock to the processing unit 20. The ISR epilogue then generates the power mode transition notification (see Box 540) and changes the global variable that represents the current power mode (see Box 550), as described above.

The present system and method have many advantages. As noted above, the use of an idle task to enter and exit sleep mode consumes valuable resources. An idle task has its own context which must be restored and saved upon entry and exit into the idle task. This consumes memory space that must remain powered during sleep mode. Additionally, this context switching requires time to perform, which may affect the overall performance of the device. The present mechanism eliminates the idle task by utilizing the SLEEP ON EXIT feature of certain ARM processors. Additionally, the present disclosure includes means to allow the ARM processor to operate in both handler and thread mode while making use of this feature.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of managing sleep mode in a real time operating system (RTOS) environment, comprising:
operating an ARM processor in both handler mode and thread mode;
implementing a SLEEP ON EXIT feature of an ARM processor to enter sleep mode after all interrupts are serviced and no tasks are ready to execute; and
disabling the SLEEP ON EXIT feature when a task is determined to be ready to execute.

2. The method of claim 1, wherein a PendSV exception handler is a lowest priority exception and is used to enable the SLEEP ON EXIT feature when no tasks are ready to execute.

3. The method of claim 2, wherein the PendSV exception handler determines which one of two or more sleep modes to enter if the SLEEP ON EXIT feature is enabled.

4. The method of claim 2, wherein the PendSV exception handler restores context of a task if the task is ready to execute.

5. The method of claim 1, wherein each interrupt service routine includes an ISR epilogue to execute post-sleep instructions.

6. The method of claim 5, wherein the ISR epilogue checks if the SLEEP ON EXIT feature has been disabled.

7. The method of claim 1, wherein the thread mode does not include an idle task.

8. The method of claim 1, wherein sleep mode is always entered from handler mode.

9. The method of claim 8, wherein sleep mode is entered from an interrupt service routine.

10. A device, comprising:
an ARM processor;
a memory device in communication with the ARM processor, containing instructions, which when executed by the ARM processor, allow the ARM processor to:
operate in both handler mode and thread mode;
implement a SLEEP ON EXIT feature to enter sleep mode after all interrupts are serviced and no tasks are ready to execute; and
disable the SLEEP ON EXIT feature when a task is determined to be ready to execute.

11. The device of claim 10, wherein the instructions include a PendSV exception handler, which is a lowest priority exception and is used to enable the SLEEP ON EXIT feature when no tasks are ready to execute.

12. The device of claim 11, wherein the PendSV exception handler determines which one of two or more sleep modes to enter if the SLEEP ON EXIT feature is enabled.

13. The device of claim 11, wherein the PendSV exception handler restores context of a task if the task is ready to execute.

14. The device of claim 10, wherein the instructions include one or more interrupt service routines, and wherein each interrupt service routine includes an ISR epilogue to execute post-sleep instructions.

15. The device of claim 14, wherein the ISR epilogue checks if the SLEEP ON EXIT feature has been disabled.

16. The device of claim 10, wherein the instructions do not include an idle task that executes in thread mode.

17. The device of claim 10, wherein sleep mode is always entered from handler mode.

18. The device of claim 17, wherein sleep mode is entered from an interrupt service routine.
